(19) United States
(12) Patent Application Publication
(10) Pub. No.: US 2026/0183801 A1
(43) Pub. Date: Jul. 2, 2026

(54) SYSTEM AND METHOD FOR IDENTIFICATION AND SORTING OF PLASTICS

(71) Applicant: Agency for Science, Technology and Research, Singapore (SG)

(72) Inventors: Lin Ke, Singapore (SG); Chun Yong Andrew Ngo, Singapore (SG); Yee Fun Lim, Singapore (SG); Kumaraesh Haridas, Singapore (SG); BingSheng Jonathan Zheng, Singapore (SG)

(21) Appl. No.: 19/131,514

(22) PCT Filed: Nov. 28, 2023
(86) PCT No.: PCT/SG2023/050788

§ 371 Date: May 20, 2025

(30) Foreign Application Priority Data
Nov. 28, 2022 (SG) 10202260230R

(51) Int. Cl. B07C 5/342; G01N 21/17; G01N 21/27

(52) U.S. Cl. CPC B07C 5/342; G01N 21/27; B07C 2501/0054; G01N 2021/1765

(57) ABSTRACT

A system operable to identify and sort materials of different plastics. The system may include an illumination module operable to emit light at materials of different plastics; an imaging module including a hyperspectral detector and a thermal imaging camera each configured to detect light from the illumination module reflected by the materials of different plastics, where the hyperspectral detector is operable to convert detected light into hyperspectral signal and the thermal imaging camera is operable to convert detected light into thermal image; and a data acquisition module including a hyperspectral signal processing unit and a thermal signal processing unit, where the hyperspectral signal processing unit is operable to generate hyperspectral data from the hyperspectral signal and the thermal signal processing unit is operable to generate thermal imaging data from the thermal image for use in identifying the materials of different plastics.

### CROSS-REFERENCE TO RELATED APPLICATION

This application claims the benefit of priority of Singapore patent application no. 10202260230R filed 28 Nov. 2022, the contents of which being hereby incorporated by reference in its entirety for all purposes.

### TECHNICAL FIELD

Various embodiments relate to a system and method for identification and sorting of plastics.

### BACKGROUND

Plastic, being a type of polymer, is a popular and highly versatile material. Various plastic polymers have been widely used for packaging, storage such as containers and bottles, semiconductor devices, electrical insulation, and other applications. With the rapid progress of polymer materials science and technology, application of plastics has been further extended. At present, the number of plastics has grown to more than 300 different categories. They are different in properties, such as crystal form, hardness, flexibility, light transmittance, and thermal conductivity.

For sustainability purposes, there is increasing need to effectively detect, sort, recycle, and reuse plastics. Even though recycling and upcycling are able to reduce the need to create new plastics, recycling rate of plastic is only 4% at present. One reason for this is lack of an effective sorting method. Even though infrared (IR) spectroscopy may be adopted for plastic sorting, it does not provide low-frequency information of substances. In addition, penetration of IR is limited to the surface due to the wrapping materials, and sorting of colored plastics, in particular dark-colored plastics, continue to pose a challenge. Further improvements are needed to enhance plastic sorting capability.

In light of the above, there remains a need for an improved system and method for sorting plastics that address or at least alleviate one or more of the above-mentioned problems.

### SUMMARY

Various embodiments refer in a first aspect to a system operable to identify and sort materials of different plastics. The system may comprise:
an illumination module operable to emit light at materials of different plastics, wherein the illumination module comprises a hyperspectral optical source and a thermal excitation source, wherein the hyperspectral optical source is operable to emit light ranging from ultraviolet light to infrared light;
an imaging module comprising a hyperspectral detector and a thermal imaging camera each configured to detect light from the illumination module reflected by the materials of different plastics, wherein the hyperspectral detector is operable to convert detected light into hyperspectral signal and the thermal imaging camera is operable to convert detected light into thermal image; and
a data acquisition module comprising a hyperspectral signal processing unit and a thermal signal processing unit, wherein the hyperspectral signal processing unit is operable to generate hyperspectral data from the hyperspectral signal and the thermal signal processing unit is operable to generate thermal imaging data from the thermal image, wherein the materials of different plastics are identifiable from the hyperspectral data and the thermal imaging data.

Various embodiments refer in a second aspect to a system operable to identify and sort materials of different plastics. The system may comprise:
an illumination module operable to emit light at materials of different plastics, wherein the illumination module comprises a terahertz infrared broadband emission source operable to emit light;
an imaging module comprising a terahertz infrared detector coupled to a prism, wherein the prism is positioned to contact each of the materials in the absence of any force exerted on the prism and the materials to render the contact, wherein the terahertz infrared detector is configured to detect light from the illumination module reflected by the materials of different plastics, wherein the terahertz infrared detector is operable to convert detected light into terahertz signal, wherein the prism renders attenuated total reflection; and
a data acquisition module comprising a terahertz signal processing unit operable to generate a time domain data from the terahertz signal, wherein the materials of different plastics are identifiable from one or more properties of the materials of different plastics calculated using the time domain data.

Various embodiments refer in a third aspect to a plastic sorting system comprising the system according to the first aspect and the system according to the second aspect.

Various embodiments refer in a fourth aspect to a method of identifying and sorting materials of different plastics. The method may comprise:
operating the illumination module in a system of the first aspect or the second aspect to emit light at materials of different plastics;
configuring the imaging module in a system of the first aspect or the second aspect to detect light from the illumination module reflected by the materials of different plastics; and
having the data acquisition module in a system of the first aspect generate hyperspectral data and thermal imaging data for identifying the materials of different plastics or having the data acquisition module in a system of the second aspect generate a time domain data for identifying the materials of different plastics.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 is a schematic diagram depicting electromagnetic (EM) spectrum with zoom-in on infrared (IR) and terahertz (THz) spectra.

FIG. 2 is a photograph depicting visual from left to right (both rows) of various plastic samples of: polystyrene (PS), polypropylene (PP), low density polyethylene (LDPE), polyethylene terephthalate (PET).

FIG. 3 is an image showing hyperspectral points of interest selection, from left to right (both rows) of various plastics of: PS, PP, LDPE, PET (corresponding to samples shown in FIG. 2). X-axis of the graph denotes wavelength (nm); y-axis denotes reflectance (%). Prefix of curve label “(1)” denotes first row and “(2)” denotes second row. For example, “(1) PP” denotes PP sample from first row whereas “(2) PP” denotes PP sample from second row. The wording “836.425” at the bottom left corner of the figure represents wavelength of the hyperspectral image being viewed, and serves merely to provide user with information of the wavelength at which the image is being viewed at (in this case 836.425 nm). The wording “178, 199” shown at the LDPE sample represents the (x, y) coordinates of where the cursor was selected and serves merely to provide user with this information. As can be seen from the figure, the dark colored (black and dark maroon) PS, PP, LDPE, PET plastics pose an obstacle for hyperspectral imaging (HSI) to identify and classify.

FIG. 4 is an image showing hyperspectral classified bands at wavelength 867 nm, from left to right (both rows) of various plastics of: PS, PP, LDPE, PET (corresponding to samples shown in FIG. 2). X-axis of the graph denotes wavelength (nm); y-axis denotes reflectance (%). (1) denotes first row and (2) denotes second row. Therefore, “(1) PP” for example denotes PP sample from first row whereas “(2) PP” denotes PP sample from second row. The wording “867.842” at the bottom left corner of the figure represents wavelength of the hyperspectral image being viewed, and serves merely to provide user with information of the wavelength at which the image is being viewed at (in this case 867.842 nm). As can be seen from the figure, the dark colored (black and dark maroon) PS, PP, LDPE, PET plastics pose an obstacle for hyperspectral imaging to identify and classify.

FIG. 5 is a photograph showing part of sample collections of (from top to bottom and left to right): polyethylene-transparent film (PE-transparent film), PE-light green film, PE-light blue film, polypropylene-Microwave box cover (PP-Microwave box cover), polytetrafluoroethylene-transparent film (PTFE-transparent film), PTFE-red film, polycarbonate-thick sheet (PC-thick sheet), PP-red sheet, PC-thin sheet, polymethyl methacrylate thin sheet (PMMA thin sheet), and PET thin sheet.

FIG. 6A is a photograph showing active thermography setup according to an embodiment. Halogen lamps were used as the thermal excitation source. A thermal imaging camera in the form of IR camera is used to detect reflected light from the samples.

FIG. 6B is a photograph showing hyperspectral imaging setup according to an embodiment. Halogen lamps were used as the hyperspectral optical source. A hyperspectral detector in the form of HSI camera is used to detect reflected light from the samples. A push broom scanner is shown for obtaining images.

FIG. 7 is an image showing PET plastic HSI visual and experimental results (left), and active thermography visual and experimental results (right). As shown in the figure, black colored plastic, which is hardly discernible in HSI visual, is highlighted under active thermography (highlighted by the box).

FIG. 8 is an image showing high density polyethylene (HDPE) plastic HSI visual and experimental results (left), and active thermography visual and experimental results (right). As shown in the figure, dark blue colored plastic, which is hardly discernible in HSI visual, is highlighted under active thermography (highlighted by the box).

FIG. 9 is an image showing LDPE plastic HSI visual and experimental results (left), and active thermography visual and experimental results (right). As shown in the figure, black colored plastic, which is hardly discernible in HSI visual, is highlighted under active thermography (highlighted by the box).

FIG. 10A is a schematic diagram showing a THz time domain spectra (TDS) system 1000 according to embodiments. Fs laser 1001 provides a laser 1002, which is reflected by a reflector 10031 to a beam splitter (BS) 1005. The beam splitter (BS) 1005 splits the laser into a first laser directed to first reflector 10032 and a second reflector 10033. The laser that is directed to the first reflector 10032 is directed to 1007 (delay stage) to result in delay line 1004 and reflected via reflectors 10034, 10035, 10036 and 10037 to a neutral-density (ND) filter 10091, which may be configured to moderate or reduce intensity of laser passing through the ND filter 10091. The laser passing through the ND filter 10091 may be reflected by reflector 10038 to a first principal component analyser (PCA) 10111, and a silicon prism 1013. Meanwhile, the laser that is directed to the second reflector 10033 is directed to a neutral-density (ND) filter 10092, which is in turn reflected by reflectors 10039 and 10040 to a second principal component analyser (PCA) 10112, and the silicon prism 1013.

FIG. 10B is a schematic diagram showing path of the propagating THz wave inside the Si prism and property calculation of the analyte. In order to perform an Attenuated Total Reflection (ATR) measurement, a sample may be deposited onto the prism base. In the embodiment shown, length L of the sample is 3.2 cm. The prism may be inserted into the THz path to allow in- and out-coupling of a THz beam either with transverse electric (TE) or with transverse magnetic (TM) mode. With a proper prism design, the THz beam may experience total internal reflection at the prism-sample interface to create an evanescent field inside the sample close to the reflecting boundary. After reference and sample signals are recorded, THz waveforms of the reference and sample measurements may be Fourier transformed.

FIG. 11 shows reflection maximum intensity distribution of various plastic samples of PP, PS, HDPE, LDPE and PET. The results show that certain types of plastic can potentially be differentiated just by considering the maximum reflection intensity. From FIG. 11, two outliers labeled HDPE 7 and PS5 with word may be seen. Upon closer inspection, the sample PS5 with word was expected to cause some error in the data as the sample itself has inscriptions on it that causes the sample to be non-uniform. HDPE 7 as a sample was less rigid than the remaining HDPE samples. This may have resulted in movement during THz measurement that caused the outlier data point.

FIG. 12 is a graph depicting THz TDS time domain spectra of various plastic types of HDPE (1201), LDPE (1203), PET (1205), PP (1207), and PS (1209). The time delay may relate or correlate with different spacings between the prism stage and sample surface.

FIG. 13 is a graph depicting refractive index calculation for different plastic types of HDPE, LDPE, PET, PP, and PS.

FIG. 14A is a graph depicting Neural Network (NN) classifier predictions for different types of plastics of HDPE, LDPE, PET, PP, and PS, for Training Set.

FIG. 14B is a graph depicting Neural Network (NN) classifier predictions for different types of plastics of HDPE, LDPE, PET, PP, and PS, for Test Set.

FIG. 15 is a graph showing Principal Component Analysis (PCA) results after Machine Learning Process, of ATR amplitude against sample number for different types of plastics of HDPE, LDPE, PET, PP, and PS.

FIG. 16 is a schematic diagram showing a set-up 1600 for plastic sorting, including a conveyor belt 1609 for plastics, with thermal camera 1601, hyperspectral camera 1603 and excitation source 1605 positioned above the manufacturing line according to embodiments. It illustrates a setup 1600 which uses an excitation source 1605 to provide optical illumination for the hyperspectral imaging system, as well as thermal excitation for the thermal imaging system. Plastics 1607 passing on the conveyor belt 1609 are illuminated and thermally excited by the excitation source 1605, the hyperspectral imaging system comprising hyperspectral camera 1603 captures hyperspectral data cubes which are processed through machine learning to identify different plastic types, while the thermal imaging system comprising the thermal camera 1601 is able to easily identify dark colored plastics through their high thermal contrast which can then be identified using a THz-TDS (ATR mode) process disclosed herein.

FIG. 17 is a schematic diagram for THz ATR setup 1700, jointly applied with conveyor belt 1709. It shows a set-up for plastic sorting, including a conveyor belt 1709 for plastics, with Si prism 1713, IR/Far IR (THz) emission source 1715 and IR/Far IR (THz) detection 1717 for spectra and imaging. This ATR set-up comprising 1713, 1715 and 1717 is placed at a specific location (1711) along the conveyer belt. 1701 represents the alignment camera placed before the samples reach the ATR set-up used to identify the location of the samples along the belt.

FIG. 18 is a schematic diagram showing THz ATR Reflection Spectra. (e.g. HDPE). The inset figure shows a sample 1807 and prism 1813 depicting ATR. Signals 1 and 2 transmitted through the prism translate into peaks 1 and 2 in the graph.

FIG. 19 is a schematic diagram depicting operation 1900 of a combined system according to embodiments disclosed herein. Waste plastic for sorting at 1901 may be provided to a conveyor system leading to a sorting area at 1903. Red, green and blue (RGB) technology may be used to detect position of the incoming waste plastic at 1905. Excitation with halogen lamps may be carried out at 1907, followed by an infrared thermography (IRT) process 1910 or a hyperspectral imaging (HSI) process 1920.

In the IRT process 1910, infrared thermography (IRT) may be applied at 1911 to capture live images of thermally excited plastic at 1913. Presence of any thermal images with high thermal contrast difference may be determined at 1915.

If yes 1916, i.e. there are thermal images with high thermal contrast difference, machine learning (ML) is used to identify dark colored plastics of high thermal contrast difference at 1917. Subsequently, THz-TDS (ATR mode) process 1930 is used. THz-TDS (ATR mode) is used at 1931 to characterize properties of the plastics using known references at 1933. ML is used to classify and differentiate plastic types at 1935.

Otherwise, if no 1918, i.e. if there are no thermal images with high thermal contrast difference, HSI process is used at 1919. In the HSI process 1920, hyperspectral imaging (HSI) is used at 1921. HSI images are captured and processed at 1923. Plastics are selected using positioning data from ML at 1925. ML is used to classify and differentiate plastic types at 1927.

Following use of ML to classify and differentiate plastic types from either one or both of THz-TDS (ATR mode) process at 1935 and HSI process at 1927, automation process is used at 1940. Automation robotics are used to sort the plastics being differentiated at 1941, such as into categories of HDPE 1942, LDPE 1943, pp 1944, PS 1945, PET 1946 and Others 1947.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Systems and methods according to various embodiments disclosed herein may relate to hyperspectral imaging (HSI) technique, which refers broadly to a technique that analyses a wide spectrum of light from across the electromagnetic spectrum. Light that is irradiated on and reflected from an object to reach each pixel of an image received by a hyperspectral detector may be broken down into many different continuous spectral bands, which provide more information on the object that is being imaged as compared to RGB technology. By measuring the energy reflected, transmitted, or emitted from the object with a hyperspectral imaging system, unique color signatures or spectral fingerprint of the object may be detected. In so doing, it is possible to classify or identify the object based on its spectral fingerprint on a level that is not possible using a conventional color camera or thermal imager.

As disclosed herein, the HSI technique may be complemented with thermography technique for identification and sorting of plastics. This is advantageous, particularly for dark-coloured plastic materials, which remain a challenge for HSI as dark colors (e.g. dark colored plastics), such as black, absorb most, if not all, of the light emitted on them. This means that the light (or light having the desirable wavelengths) may not be reflected (or sufficiently reflected) into a hyperspectral detector. This may result in very low values (e.g. intensity values), such as but not limited to, 40% or lower, 30% or lower, 20% or lower, 10% or lower, 5% or lower, etc.) when plotted on the reflectance axis (vertical axis) of a hyperspectral plot, and observation of these low values tends to be consistent across the entire wavelength axis (horizontal axis) of a hyperspectral plot. This may then result in little (or even no) spectra signatures corresponding to black and/or dark-colored plastics identifiable, hence rendering their detection difficult or impossible. In various instances, the black and/or dark-colored plastics may even be invisible to the hyperspectral detector.

Use of thermography (such as thermal imaging and thermal excitation source described in various embodiments herein) may help plastic materials to be detected more easily, in particular for dark-colored plastics, due to the increased emissivity of dark colored objects as they heat up much faster than lighter colors, which appear more prominent in comparison to non-darker objects on thermal images. Even though dark plastic materials may be difficult to detect using hyperspectral imaging due to low reflectance, they may be easily picked up by active thermography. Use of active thermography in conjunction with hyperspectral imaging may overcome detection difficulties for dark plastic material identification, which further improve conventional IR techniques in the plastic sorting industry.

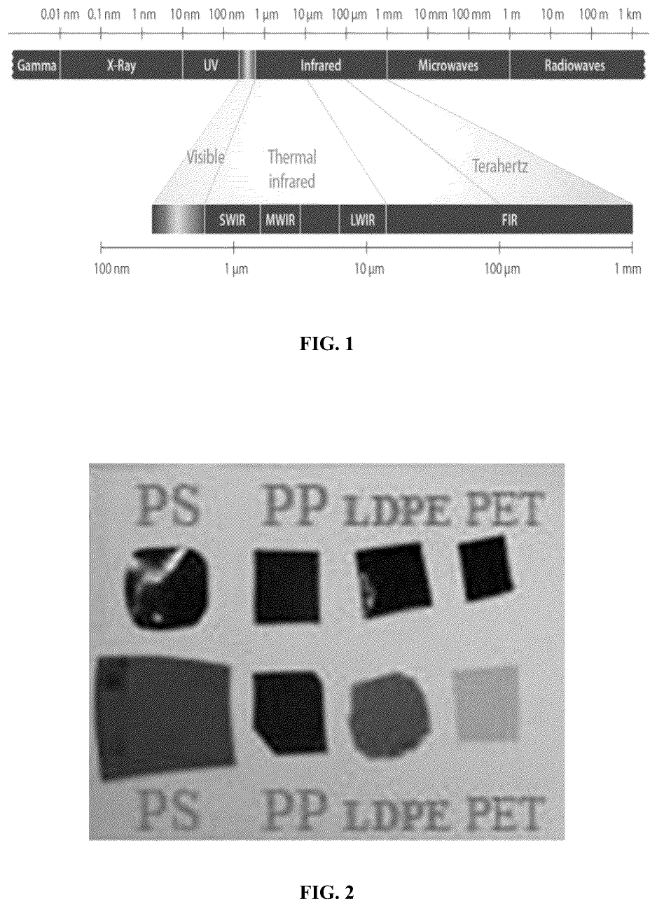

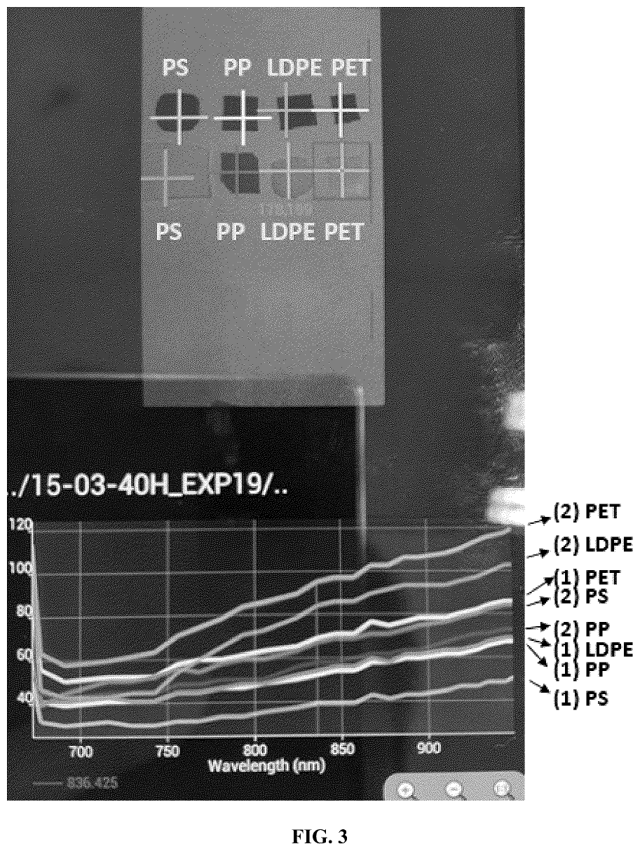

Also disclosed herein are systems and methods relating to far IR (THz) spectroscopy. Generally, a far IR (THz) spectroscopy system may include a terahertz infrared broadband emission source operable to generate THz radiation for irradiating a sample and a terahertz infrared detector operable to receive THz radiation response from the irradiated sample, and providing indication (electric signal) of the strength and/or time domain data of the detected radiation from the sample. In this connection, FIG. 1 shows the electromagnetic (EM) spectrum, with zoom-in on infrared (IR) and terahertz (THz) spectra. Use of longer wavelength range in the far IR (THz) region may enhance penetration range and expand the fingerprint identification frequency range. This may alleviate limitations on the above from use of near and mid-IR band spectra for plastic detection, and may allow more relevant information such as low-frequency information to be obtained and result in improved plastic sorting.

Features relating to Attenuated Total Reflection (ATR) may furthermore be adopted in the far IR (THz) spectroscopy technique disclosed herein. By carrying out ATR such as through use of a prism, this may allow plastic sorting to be carried out using continuous processing line such as conveyor belt, as it is not necessary to hold the materials of plastic onto a surface for measurement. In generating the plastic spectrogram to determine the type of polymer or identify the different types of plastic categories, the second THz peak picked up may correspond to air-plastic interface, which can be processed to de-noise and normalize and provide useful information about the plastic material.

With the improved detection, sorting efficiency may be improved. Embodiments disclosed herein may be used in real time detection in a process flow line such as along a conveyor belt for plastic sorting.

With the above in mind, various embodiments refer in a first aspect to system operable to identify and sort materials of different plastics.

As used herein, the term “plastics” refers generally to a solid material comprising a polymer. The term “identify” refers to determination of the type and/or characteristics of a particular material of plastic. In so doing, each plastic material may be assigned or tagged with an identity. Following identification, each identified plastic material may be sorted accordingly based on their identity. For example, each identified plastic material may be separated, classified and/or categorized into different groupings based on type and/or color of the plastic.

In various non-limiting embodiments, the plastic may be a synthetic, non-naturally occurring material. The plastic may, for example, comprise or consist of polymers derived from petroleum and/or petrochemical resources or feedstocks. Non-limiting examples of plastics may include polyolefins such as polyethylene and polypropylene, styrene-based polymers such as polystyrene, polyesters such as polyethylene terephthalate, methacrylate-based polymers such as poly(methyl methacrylate), fluoropolymers such as polytetrafluoroethylene, polycarbonate, polyvinyl chloride, or combinations and/or copolymers thereof. In some embodiments, plastics may comprise or consist of high density polyethylene (HDPE), low density polyethylene (LDPE), polypropylene (PP), polystyrene (PS), polyethylene terephthalate (PET), poly(methyl methacrylate) (PMMA), polyvinyl chloride (PVC), polycarbonate (PC), and polytetrafluoroethylene (PTFE).

The system disclosed herein may comprise an illumination module operable to emit light at materials of different plastics, wherein the illumination module comprises a hyperspectral optical source and a thermal excitation source.

As mentioned above, hyperspectral imaging or HSI refers to a spectral imaging technique which collects and processes information from across the electromagnetic spectrum. With this in mind, the hyperspectral optical source may be operable to emit light ranging from ultraviolet light (UV) to infrared (IR) light. For example, the hyperspectral optical source may be operable to emit light having a wavelength in the range of ultraviolet to infrared, so as to confer a better wavelength coverage for detection of plastics. The wavelength range may be extended even up to the mid-wavelength range of 2500 nm, up to 3000 nm, 4000 nm, and/or even up to 5000 nm.

In various non-limiting embodiments, the hyperspectral optical source is operable to emit light having a wavelength of 350 nm to 5000 nm, such as 350 nm to 3500 nm, 350 nm to 2500 nm, 2500 nm to 5000 nm, 3500 nm to 5000 nm, or 2500 nm to 3500 nm. In specific embodiments, the hyperspectral optical source is operable to emit light having a wavelength in the range of 350 nm to 3500 nm.

In various non-limiting embodiments, the hyperspectral optical source comprises halogen lamps. Halogen lamps may be advantageous as they may be able to satisfy the excitation needs of hyperspectral imaging (HSI) and thermal imaging (IRT).

Suitable halogen lamps may include halogen lamps having a power rating in the range of 300 W to 500 W, such as 300 W to 400 W, 350 W to 400 W, 400 W to 450 W or 350 W to 450 W. In specific embodiments, the hyperspectral optical source may comprise two halogen lamps, each having a power rating of 400 W.

The thermal excitation source may comprise one or more light sources, such as one, two, three or a plurality of light sources. The one or more light sources may comprise one or more halogen lamps and/or may be operable to project light comparable to natural sunlight.

In various non-limiting embodiments, the thermal excitation source comprises one or more halogen lamps. As mentioned above, halogen lamps may be advantageous as they may be able to satisfy the excitation needs of hyperspectral imaging (HSI) and thermal imaging (IRT). Suitable halogen lamps are already discussed above. In specific embodiments, the thermal excitation source may comprise two halogen lamps, each having a power rating of 400 W.

In various non-limiting embodiments, the thermal excitation source comprises a light source that is able to project light that is comparable to natural sunlight. In this regard, natural sunlight may be advantageous as it may provide a wide broadband spectrum that satisfies the excitation needs of HSI and IRT.

The system disclosed herein may comprise an imaging module comprising a hyperspectral detector and a thermal imaging camera each configured to detect light from the illumination module reflected by the materials of different plastics, wherein the hyperspectral detector is operable to convert detected light into hyperspectral signal and the thermal imaging camera is operable to convert detected light into thermal image.

In various non-limiting embodiments, the hyperspectral detector is operable to detect light having a wavelength of at least 400 nm reflected by the materials of different plastics. For example, the hyperspectral detector may be a hyperspectral detector operable to detect light (e.g. light reflected from a plastic material) having a wavelength in the range of 400 nm to 1000 nm. However, the hyperspectral detector is not limited to detect light having aforesaid wavelengths. The hyperspectral detector may be operable to detect light in the visible to near-infrared wavelength range, and/or near-infrared to short-wave infrared (e.g. 900 nm to 1700 nm), and/or beyond the aforesaid ranges.

In various non-limiting embodiments, multiple hyperspectral detectors may be used so as to detect light of multiple wavelength ranges. For example, a first hyperspectral detector may be used to detect light of a first wavelength range, while a second hyperspectral detector may be used to detect light of a second wavelength range that is higher than that detected by the first hyperspectral detector. The first wavelength range and the second wavelength range may or may not be overlapping.

In various non-limiting embodiments, the thermal imaging camera is operable to convert detected light into thermal image. Based on information from the detected light, a thermal image showing spatial distribution of temperature differences across a surface of the illuminated object may be obtained.

The system operable to identify and sort materials of different plastics may comprise a data acquisition module comprising a hyperspectral signal processing unit and a thermal signal processing unit, wherein the hyperspectral signal processing unit is operable to generate hyperspectral data from the hyperspectral signal and the thermal signal processing unit is operable to generate thermal imaging data from the thermal image, wherein the materials of different plastics are identifiable from the hyperspectral data and the thermal imaging data.

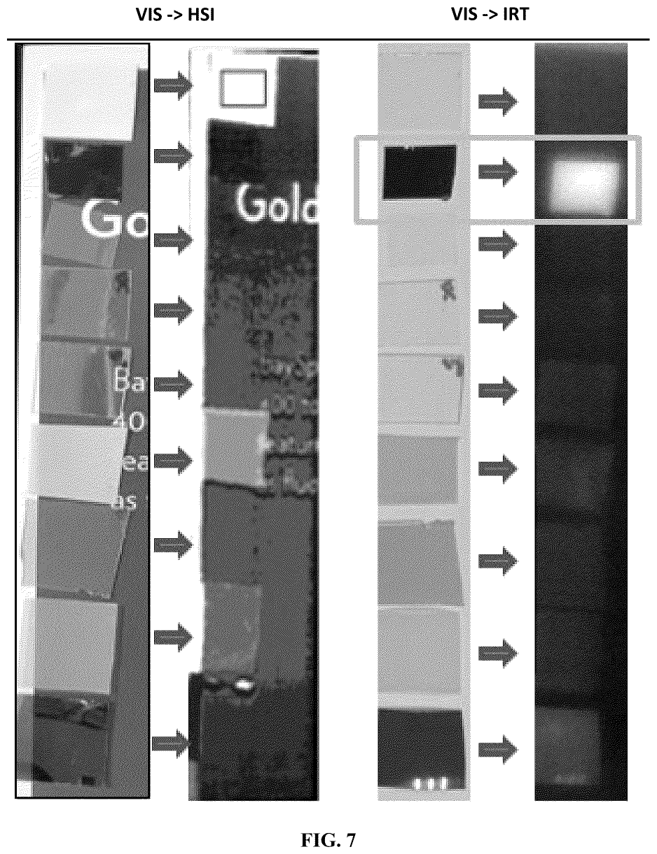

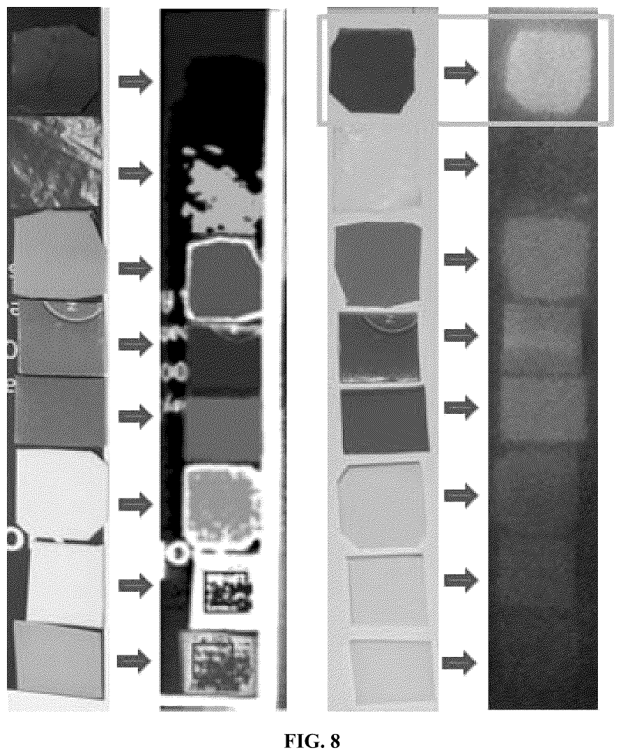

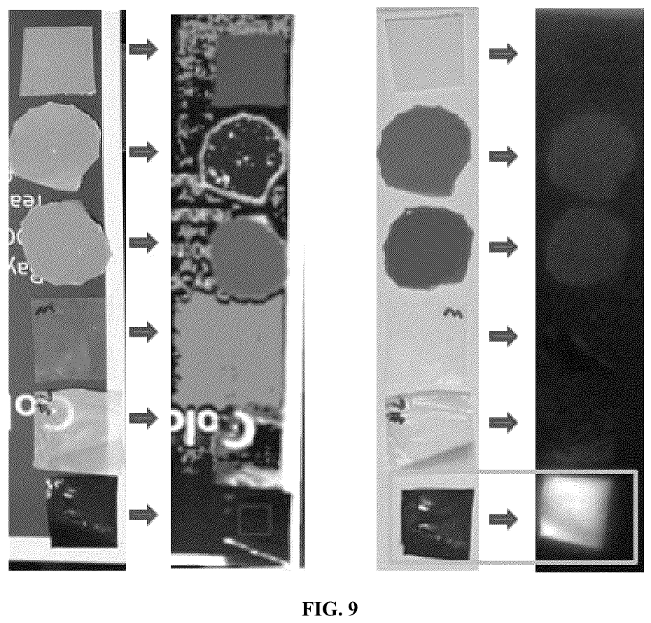

As mentioned above, by complementing active thermography with hyperspectral imaging, identification and sorting of plastics may be carried out in an improved manner, in particular for detection of dark plastic materials. Examples may be seen from FIG. 7 to FIG. 9, whereby dark colored plastics which are not discernible using HSI may be distinguished using active thermography.

In various non-limiting embodiments, the hyperspectral optical source, the thermal excitation source, the hyperspectral detector and the thermal imaging camera, may be portable. In various non-limiting embodiments, the hyperspectral optical source, the thermal excitation source, the hyperspectral detector and the thermal imaging camera, may be portable but remain stationary during operation due to pre-calibration requirements, such as the white and black reflectance calibration settings for the hyperspectral detector and lens focusing of the thermal imaging camera. In specific embodiments, the hyperspectral optical source, the thermal excitation source, the hyperspectral detector and the thermal imaging camera, remain stationary during operation.

As disclosed herein, the system may further comprise a machine learning module trainable to identify the materials of different plastics and have the conveyer module categorize the materials of different plastics for sorting.

This can be applied and/or configured, as the spectra data of known plastics can be fed as input to the machine learning module so as to allow machine learning and then compared with the data acquired by the hyperspectral detector during the system operation in order to categorize the different plastics for sorting.

For example, material parameters such as absorption spectra, refractive index and/or dielectric constant may be used to implement machine learning in generating reference values. Based on data acquired by the the hyperspectral detector during system operation, respective absorption spectra, refractive index and/or dielectric constant of plastic samples may be calculated, and compared with that of the reference values. In so doing, identification of the plastic samples may be carried out prior to sorting, so that the sorting may be carried out accurately and/or efficiently.

Advantageously, a machine learning workflow is able to aid in improving efficiency and accuracy of plastic sorting, by determining, for example, predictive accuracies and confusion matrices, and determining probability of a prediction. Applications may include sorting plastic waste or other materials along the convey belt or manufacturing line for recycling, and characterization of various materials and obtaining of material parameters.

Various embodiments refer in a second aspect to a system operable to identify and sort materials of different plastics.

The system may comprise an illumination module operable to emit light at materials of different plastics, wherein the illumination module comprises a terahertz infrared broadband emission source operable to emit light.

In various non-limiting embodiments, the terahertz infrared broadband emission source is operable to emit light having a wavelength in the terahertz range. For example, the light emitted may be an electromagnetic wave that has a frequency in the range of 100 GHz (0.1 THz) to 10 THz, such as 0.1 THz to 8 THz, 0.1 THz to 6 THz, 0.1 THz to 4 THz, 0.1 THz to 2 THz, 1 THz to 10 THz, 2 THz to 10 THz, 4 THz to 10 THz, 6 THz to 10 TH, 4 THz to 8 THz or 3 THz to 5 THz. In specific embodiments, the light emitted is an electromagnetic wave having a frequency in the range of 0.1 THz to 4 THz.

In various non-limiting embodiments, the light emitted may be an electromagnetic wave having a wavelength in the range of 3 mm to 30 μm.

The system may comprise an imaging module comprising a terahertz infrared detector coupled to a prism, wherein the prism renders attenuated total reflection.

As used herein, the term “attenuated total reflection” refers generally to a technique whereby a beam of light is passed through the prism in such a way to achieve total internal reflection and the beam of light reflects at least once off the internal surface at a side of the prism that is in contact with the sample. This reflection may form an evanescent wave which extends slightly into the sample, e.g., by a few microns. In so doing, light may be absorbed by the sample so that the transmitted light carries information such as spectral properties of the sample. The beam of light may then be collected by a detector (e.g., terahertz infrared detector) as it exits the crystal.

In various non-limiting embodiments, the prism surface may align with a surface of a conveyer belt operable to convey the materials through the system. The samples (i.e. materials of different plastics) may come into contact with a surface of the prism, but the contact may be a “weak” contact, which may be defined as a contact formed without any external force to press down the materials and the prism together (e.g. no force is present to press a material onto the prism's surface). Accordingly, the prism may be positioned to contact the materials (e.g. one at a time) in the absence of any force exerted on the prism and the materials to render the contact. For example, the prism may be positioned to contact the materials (e.g. one at a time) in the absence of any lateral force exerted on the prism and the materials to render the contact. The air gap distance may preferably be kept at a minimum or as low as possible in order to facilitate more in-depth penetration of the evanescent wave inside the sample.

In embodiments whereby a conveying mechanism such as conveyor belt is used for continuous processing, for example, the materials for processing may have a thickness that is within a certain thickness range. By pre-positioning the prism at a specific height based on the certain thickness range, the prism may be able to contact the materials in the absence of any lateral force (or force acting perpendicular to the direction of motion of the materials) exerted on the prism and the materials to bring the prism and the materials together to establish contact.

The prism may be in light communication with the terahertz infrared broadband emission source and the materials of different plastics, and may be positioned in a path which the light emitted from the terahertz infrared broadband emission source travels to the materials of different plastics. It may be noted that compared to a sample that is pressed against the prism, the signal from a sample that is not pressed against the prism may have or show a longer delay time and reduced amplitude. The reason may be due to the air gap between the sample and prism, and the THz wave then takes a longer time to reach the detector with reduced intensity.

In various non-limiting embodiments, the prism can be formed of a material that has low THz spectra absorption, wherein such materials can be, for example, high resistivity silicon, high resistivity sapphire, Teflon, and/or other THz low loss polymers. A non-limiting example of a THz low loss polymer is polypropylene.

In various non-limiting embodiments, the prism comprises silicon, sapphire, Teflon, and/or polypropylene.

In various non-limiting embodiments, the prism may have a resistivity of 7 kΩ-cm or more, such as 8 kΩ-cm or more, 9 kΩ-cm or more, or 10 kΩ-cm or more. In certain non-limiting instances, the resistivity may be more than 7 kΩ-cm where the prism is formed of high resistivity silicon for low loss THz transmission. In certain non-limiting instances, a criterion for selecting a material for the prism may be a material that has high transmission of THz broadband spectra of 80% to 90% in the range of 0.1 THz to 3.5 THz.

The terahertz infrared detector may be configured to detect light from the illumination module reflected by the materials of different plastics, wherein the terahertz infrared detector is operable to convert detected light into terahertz signal.

The system disclosed herein may comprise a data acquisition module comprising a terahertz signal processing unit operable to generate a time domain data from the terahertz signal, wherein the materials of different plastics are identifiable from one or more properties of the materials of different plastics calculated using the time domain data.

In various non-limiting embodiments, the one or more properties of different plastics calculated using the time domain data comprise refractive index of a plastic, absorption coefficient of a plastic, and/or dielectric constant of a plastic.

The data acquisition module may be operable to identify a terahertz signal which corresponds to a prism-air interface from the time domain data and discounting the terahertz signal corresponding to the prism-air interface from one or more other terahertz signals to identify one or more terahertz signals respectively corresponding to the materials of different plastics. Non-limiting examples of machine learning algorithm may include, Support Vector, Random Forest, Gradient Boosting, and Neural Network classifiers. Predictive accuracies and confusion matrices, and/or probability of a prediction may be made concurrently.

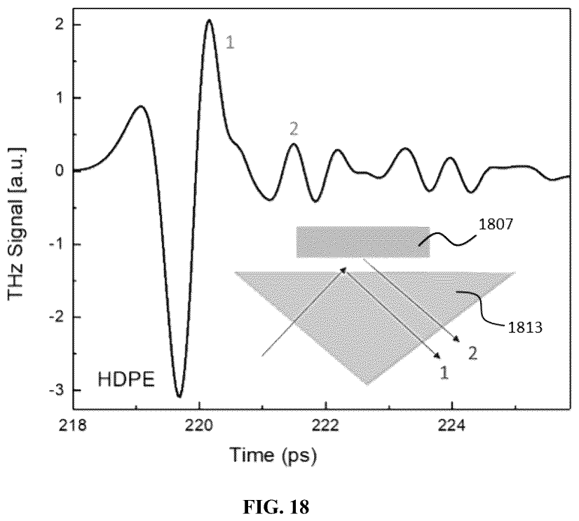

For purpose of illustration, FIG. 18 is being referred to. As can be seen in the figure, the air gap between the sample (a plastic material) and the prism is enlarged for clarity, the multiple reflection peaks with different delay time can be used to extract information from the sample(s). Using, for example, a signal analyzing technique, such as but not limited to deconvolution, the information from the sample can be extracted to identify the plastic. Also, as shown in FIG. 18, the second THz peak (denoted by peak numbered 2 and arrow 2) corresponds to the air-sample (e.g. air-plastic) interface.

As disclosed herein, the system may further comprise a conveyer module which conveys the materials of different plastics from one point to another in the system and an electronic module operable to continuously adjust the terahertz infrared broadband emission source and the terahertz infrared detector, to a position along the conveyer module for (i) the terahertz infrared broadband emission source to emit light at one or more of the materials and (ii) the terahertz infrared detector to detect the light reflected by the materials of different plastics.

The electronic module be used specifically in the system operable to identify and sort materials of different plastics using terahertz (THz) infrared detection.

In various non-limiting embodiments, the prism may be arranged underneath the conveyer module (e.g. underneath a conveyer belt of the conveyer module) and the electronic module may be configured to have the terahertz infrared broadband emission source and the terahertz infrared detector (for transmission of light onto the materials and detection of light reflected from the materials, respectively) positioned along the prism so as to collect the reflection signal from the materials (e.g. plastic samples).

As disclosed herein, the system may further comprise a machine learning module trainable to identify the materials of different plastics and have the conveyer module categorize the materials of different plastics for sorting. The machine learning module can be trained to automatically identify different types of plastics. Advantageously, influences from interfaces or air gaps may be removed for machine learning.

Various embodiments refer in a third aspect to a plastic sorting system comprising the system of the first aspect and the system of the second aspect. The system of the first aspect and the second aspect may act in tandem with each other to further improve accuracy and efficiency of identification and sorting of plastics.

In other words, the system operable based on hyperspectral (HSI) and thermal imaging technologies, and the system operable based on attenuated total reflection (ATR) and THz infrared technologies, can be configured into a single system.

In the present disclosure, the plastics can be subjected to ATR and THz joint inspection. As an example, in the first step, light having wavelengths in the range of 350 nm to 3500 nm from a hyperspectral optical source and a thermal excitation source (e.g. 2×400 W halogen lamps) can be directed at plastic samples. The active thermography (via thermal imaging using the thermal excitation source) may help to pick up the darker-colored plastics. Thereafter, the THz broadband spectra can be used to differentiate and identify the different types of plastics in details even if the samples are all in the same dark color.

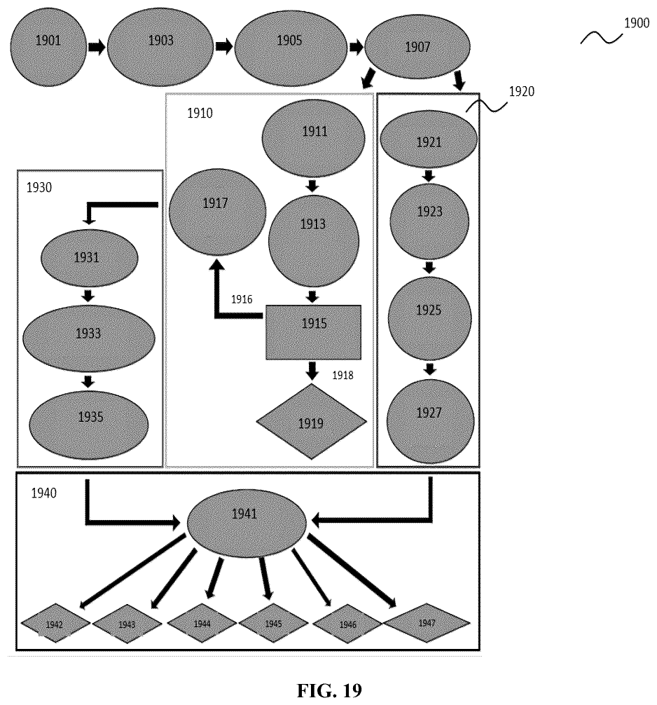

A schematic diagram depicting an embodiment relating to the operation of such a combined system is provided in FIG. 19.

As shown in FIG. 19, waste plastic for sorting may be provided to a conveyor system leading to a sorting area. RGB may be used to detect position of the incoming waste plastic. Excitation with halogen lamps may be carried out, followed by an infrared thermography (IRT) process or a hyperspectral imaging (HSI) process.

In the IRT process, live images of thermally excited plastic are captured. If there are thermal images with high thermal contrast difference, machine learning (ML) is used to identify dark colored plastics of high thermal contrast difference. Subsequently, THz-TDS (ATR mode) process is used to characterize properties of the plastics using known references. ML is used to classify and differentiate plastic types.

Otherwise, if there are no thermal images with high thermal contrast difference, HSI process is used. In the HSI process, HSI images are captured and processed. Plastics are selected using positioning data from ML. ML is used to classify and differentiate plastic types.

Following use of ML to classify and differentiate plastic types from either one or both of THz-TDS (ATR mode) process and HSI process, automation robotics may be used to sort the plastics being differentiated, such as into categories of HDPE, LDPE, PP, PS, PET and Others.

Various embodiments refer in a fourth aspect to a method of identifying and sorting materials of different plastics.

The method may comprise operating the illumination module in a system of the first aspect or the second aspect to emit light at materials of different plastics.

The method may comprise configuring the imaging module in a system of the first aspect or the second aspect to detect light from the illumination module reflected by the materials of different plastics.

The method may comprise having the data acquisition module in a system of the first aspect generate hyperspectral data and thermal imaging data for identifying the materials of different plastics or having the data acquisition module in a system of the second aspect generate a time domain data for identifying the materials of different plastics.

In various non-limiting embodiments, the method may comprise having the data acquisition module in a system of the first aspect generate hyperspectral data and thermal imaging data for identifying the materials of different plastics. The method may be followed by having the data acquisition module in a system of the second aspect generate a time domain data for identifying the materials of different plastics. In so doing, active thermography may assist in the detection of dark-colored plastics through the usage of their increased emissivity values that cause them to thermally heat up much faster than other colors, followed by use of Terahertz or hyperspectral imaging to narrow down and focus on characterizing and differentiating these plastics.

In order that the invention may be readily understood and put into practical effect, particular embodiments will now be described by way of the following non-limiting examples.

### EXAMPLES

Features of present systems and methods may include, for example, use of active thermography to complement the use of hyperspectral imaging. As demonstrated herein, dark colored plastic objects may be identified and far infrared (far IR) may be used for further dark color plastic identification. In general, black and dark plastic materials tend to have low reflectance (e.g. the amount of light reflected based on the light incident on the plastic may be 40% or lower, 30% or lower, 20% or lower, 10% or lower, 5% or lower, etc.) and are susceptible to not being adequately or accurately detected using solely hyperspectral imaging and solely traditional methods. The technology as presently disclosed can provide a non-destructive full range of plastic identification and sorting.

The proof-of-concept experimental results demonstrated the following:
1. Dark color plastic may be sorted out, and the rest of different types of plastics may be identified. Low reflectance at near-infrared for detection of dark plastic materials, which are difficult for hyperspectral imaging, may be easily picked up by active thermography due to increased emissivity.
2. Far IR (THz) sorting out the dark color plastics: in order for the present technology to be adopted in the manufacturing line, the method described herein is able to achieve identification without the need to press down the plastic samples or introduce other human interference. The overall solution is low cost and able to achieve higher efficiency. The ATR method was also demonstrated. Despite obstacles relating to different size, shape and weight of the objects, and the air gap between the ATR prism and the samples being different, signal to noise ratio may be reduced significantly, using algorithm and artificial intelligence (AI) techniques disclosed herein.

In various non-limiting embodiments, a system and method for IR/Far IR (THz) non-contact, non-destructive measurement and sorting the plastic based on different types of polymer materials and chemical properties are provided. The system may comprise:
(1) An optical source that provides a broadband wavelength for excitation, spectroscopy and imaging of either: a wavelength of 350-3500 nm acting as a hyperspectral optical source as well as a thermal excitation source (i.e. 2×400 W Halogen lamps), or a THz broadband emission of 0.1 THz to 4 THz;
(2) an illumination system configured to provide a total attenuated reflection measurement scheme;
(3) an optical system forming an optical path and shine the IR/Far IR (THz) beam on the plastic materials through a window setup on the conveyor belt;
(4) a detector system or imaging camera system for receiving reflection signals including either: a hyperspectral imaging system (wavelength, ideally: 900-1700 nm or higher, currently: 400-1000 nm; BaySpec OCI-F), or a thermal imaging system (640×480 pixels, <30 mK NETD; FLIR A655SC), or a terahertz detector system for receiving THz broadband signal;
(5) electronics to drive the measurement beam along the convey belt window and to control the IR/Far IR (THz) emission and detection;
(6) a signal processing system configured to communicate with said detection system, include either: a signal processing system to receive and process hyperspectral data cubes from the hyperspectral imaging system (for example SpecGrabber and CubeCreator Software), or a signal processing system to receive and process thermal signals from FLIR A655SC (for example ResearchIR or FLIR Thermal Studio), or a detection system to receive THz range broadband signal, wherein said signal processing system processes said detection signal to provide a measurement of plastic parameters;
(7) a machine learning workflow for sorting the plastic according to their polymer structures based on the IR/Far IR (THz) signal with the following features:
(a) Pre-processing of time domain data to identify the air-plastic material peak, remove other influencing peaks, e.g. prism-air interface peak; (b) Calculation of the absorption spectra, refractive index and dielectric constant of the plastic materials; (c) Implementation of machine learning algorithm: e.g. Support Vector, Random Forest, Gradient Boosting, and Neural Network classifiers; (d) calculation of predictive accuracies and confusion matrices; (e) Calculation of the probability of a prediction.

Through use of hyperspectral imaging, thermography, and far IR (THz range) in a proposed solution according to embodiments disclosed herein, obstacles relating to each wavelength spectrum having their pros and cons may be overcome.

### Further Technology Breakthrough in IR Range

Further technology breakthrough in IR range may be achieved, in that different types of plastics (e.g. PET, HDPE, LDPE, PS, PP, PE) are able to be differentiated and classified by the use of hyperspectral imaging. However, plastics with very dark colors (e.g. black or dark brown) pose an obstacle as they provide very low reflectance. Hyperspectral imaging in the near-infrared (NIR) range (750-2500 nm) may have difficulty in detecting and classifying very dark colored plastics as the working principle of hyperspectral imaging relies on the reflectance of the materials' spectra to provide imaging and spectral data per pixel. Therefore, the use of active thermography complements by assisting in the detection of these dark colored plastics through the usage of their increased emissivity values that cause them to thermally heat up much faster than other colors. Terahertz or hyperspectral imaging can then narrow down and focus on characterizing and differentiating these plastics.

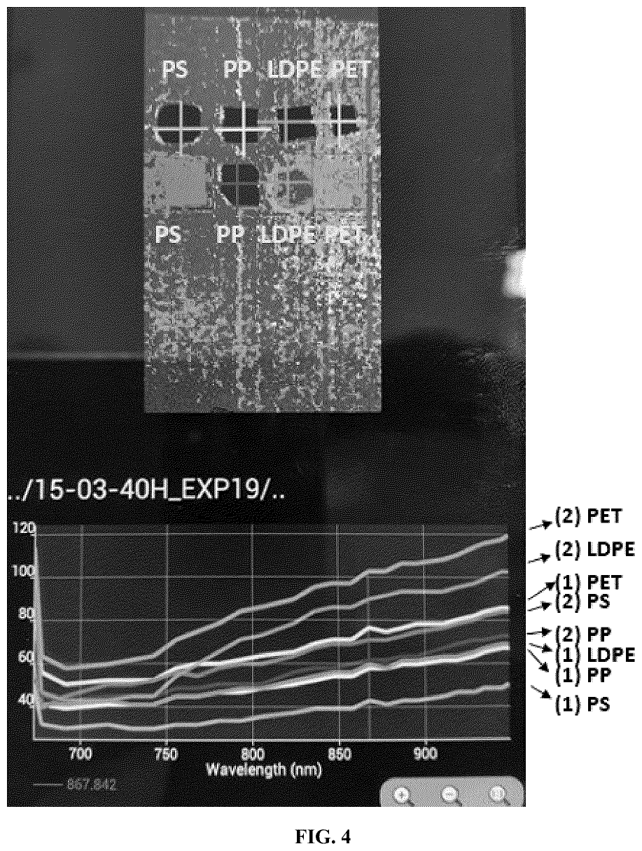

FIG. 3 is an image showing hyperspectral points of interest selection, with left to right (both rows): PS, PP, LDPE, PET. FIG. 4 is an image showing hyperspectral classified bands at wavelength 867 nm, with left to right (Both Rows): PS, PP, LDPE, PET.

As seen in FIG. 3 and FIG. 4, the dark colored (black and dark maroon) PS, PP, LDPE, PET plastics pose an obstacle for hyperspectral imaging to identify and classify.

### Expansion to Far IR (THz) Range:

Embodiments disclosed herein extend the detection technique from near IR and mid IR to far IR, which is THz range. Over the past ten years, there has been a remarkable effort in employing THz spectroscopy for investigating material properties. Pulsed THz time-domain spectroscopy (THz-TDS) is a coherent technique, in which both the amplitude and phase of a THz pulse are measured. Coherent detection enables direct calculations of both the imaginary and the real parts of the refractive index without using the Kramers-Kronig relations. From the resulting refractive index, one can obtain the absorption coefficient and the dielectric constant of the material. THz-TDS has been employed to investigate a wide variety of materials, including liquids, semiconductors, superconductors, explosive materials, and gases.

The refractive index and the absorption coefficient for most of the materials can be extracted, for example: polyethylene and teflon at the millimeter wavelengths. THz optical properties and the complex dielectric function of several polymer materials may be experimentally characterized by using transmission THz-TDS. The refractive index, the power absorption, and the complex dielectric functions in the THz region may be compared with known values for each material. The loss mechanism of THz radiation for each polymer may be determined from the measured dielectric properties. A hardware solution and software algorithm was developed to sort out various plastic waste materials.

Various embodiments disclosed herein relate to a rapid, non-invasive and non-contact, non-destructive IR/Far IR (THz) excitation, spectroscopy and imaging testing systems for sorting the plastic based on different types of polymer materials.

Embodiments of systems and methods disclosed herein including using vision camera to first capture the position of the plastic along the convey belt. Using the total attenuated reflection scheme setup under the convey belt through Si prism window to do the IR/Far IR (THz) detection. Thereafter, hyperspectral imaging and active thermography were done on different plastic samples (PET, HDPE, LDPE) to differentiate the different types of plastics. HSI to classify lighter coloured plastics with active thermography assisting to pick out darker coloured plastics that HSI could not classify.

The THz range in the electromagnetic spectrum which lies between microwave and infrared frequencies, generally in the frequencies range of 100 GHz (1011 Hz, 3 mm wavelength) to 10 THz (1013 Hz, 3.3 μm wavelength). The THz spectra may then be pre-processed to identify the air-plastic material peak, remove other influencing peaks, e.g. prism-air interface peak. Calculation of the absorption spectra, refractive index and dielectric constant of the plastic materials may be done. Based on these plastic material parameters, the machine learning algorithm may be used to sort out the plastic according to the types.

### Sample Information:

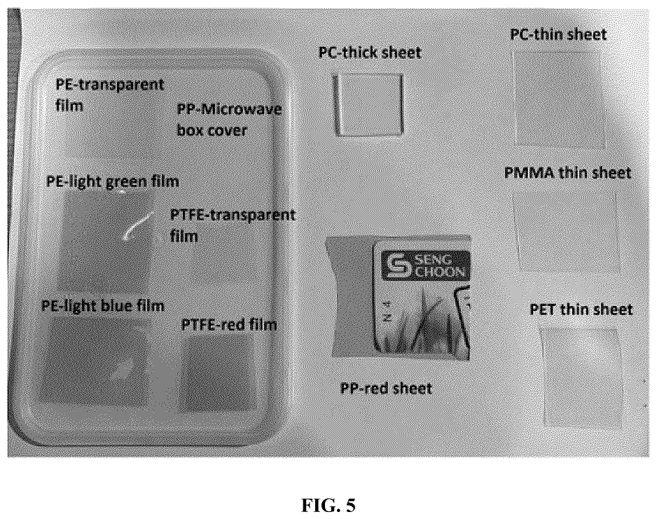

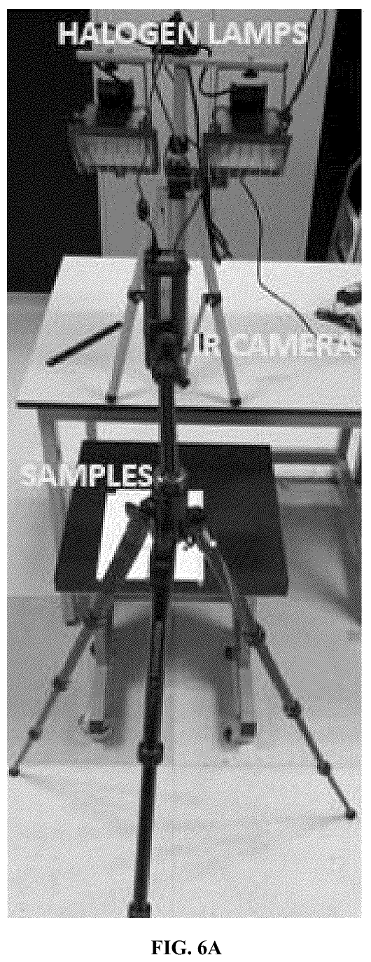

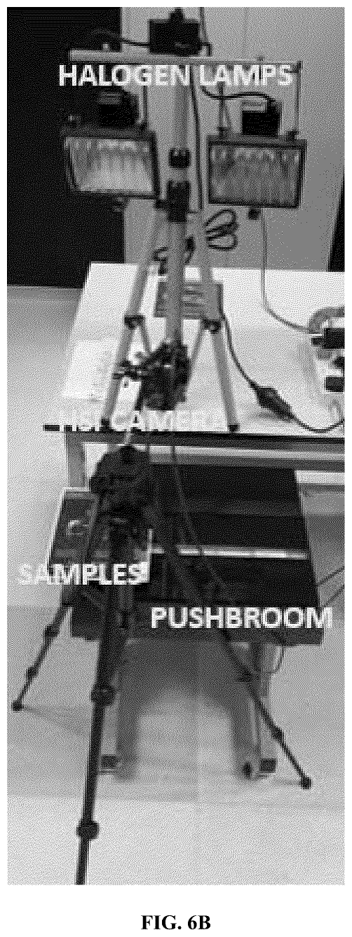

Samples tested: a series samples as shown in FIG. 5 (partially) were collected randomly, including polystyrene (PS), polypropylene (PE), polyethylene terephthalate (PET), high-density polyethylene (HDPE), low-density polyethylene (LDPE) and others [may include poly (methyl methacrylate) (PMMA), polyvinyl chloride (PVC), polycarbonate (PC), and non-plastics such as paper] etc.

### Embodiment 1: Hyperspectral Imaging and Active Thermography

Hyperspectral imaging (HSI) and active thermography were carried out on different plastic samples (PET, HDPE, LDPE) to differentiate the different types of plastics. By capturing and processing HSI data, it allows for characterization and differentiation of lighter-colored plastics. Lighter colored plastics may thereby be classified, with active thermography assisting to pick out or to detect darker colored plastics that HSI could not classify. This may be possible due to increased emissivity as a result of increased absorption.

### Embodiment 2: Attenuated Total Reflection (ATR) Mode and Far IR (THz) Spectroscopy

It is challenging for optical spectroscopy methods to detect very small amount of analyte, especially if the samples contain different substances. This is due to the low signal-to-noise ratio (SNR) since the absorption peaks of target substances may be very small and the target substances may be hard to be identified.

Ways to improve SNR of the THz measurement may include: (1) using sample-sensitive metamaterials, (2) nanoantenna arrays, (3) metal particles and quantum dots field enhancement; (4) utilizing different agents including contrast agents, optical clearing agents and aptamers etc.; and (5) optimizing the THz spectroscopy system in near-field detection. While the theoretical results of these methods are promising, few of them were realized in actual applications.

A portable THz time domain spectroscopy (THz-TDS) system with attenuated total reflection (ATR) spectroscopy mode that is capable of high-sensitivity low-concentration measurement was set up, which allowed accurate measurement of the complex dielectric function of analyte either in liquid or gaseous states, thus making it possible to resolve slight changes in dielectric constants in solution, a goal which was difficult to achieve with conventional transmission and reflection measurement mode.

Methods disclosed herein involve THz-TDS with ATR spectroscopy mode for enhanced SNR measurement. The method is able to aid in improving calculation of optical properties so that slight changes on the sample interface (e.g. small amount of organic chemical analyte) may be sensitively observed.

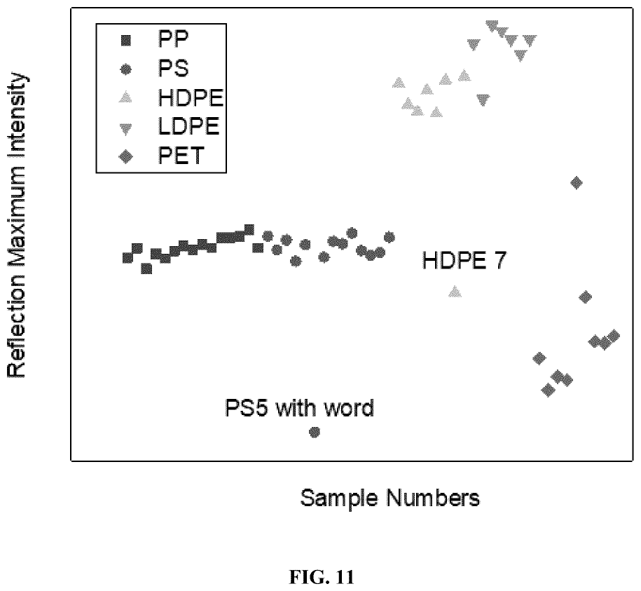

FIG. 11 shows the reflection maximum intensity collected from the samples according to different types of plastics. The results show that certain types of plastic can potentially be differentiated just by considering the maximum reflection intensity. However, complete differentiation of plastic shall be based on its material properties. By considering plastic properties such as refractive index, distinction coefficient, absorption coefficient, dielectric constants etc., the sorting and classification of the plastic materials will be even more precise.

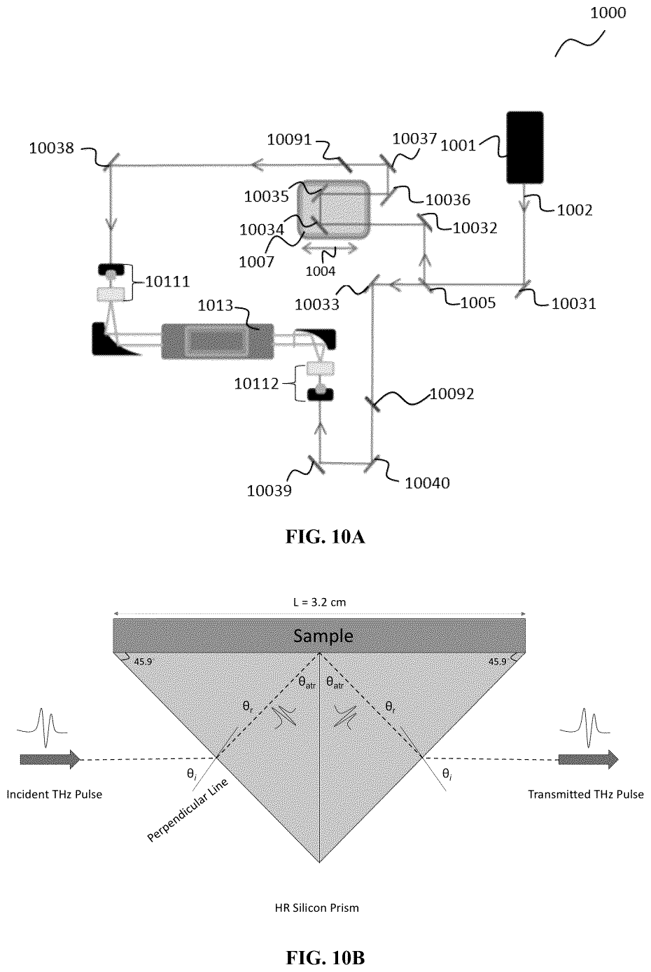

As shown in FIG. 10B, a core element of an ATR THz TDS setup is a prism. Generally, the prism may be made of high-resistivity silicon (>10 kΩ-cm) that is almost perfectly transparent and nondispersive across the THz band. In order to perform an ATR measurement, a sample may be deposited onto the prism base. The prism may be inserted into the THz path to allow in- and out-coupling of a THz beam either with transverse electric (TE) or with transverse magnetic (TM) mode. With a proper prism design, the THz beam may experience total internal reflection at the prism-sample interface to create an evanescent field inside the sample close to the reflecting boundary. After reference and sample signals are recorded, THz waveforms of the reference and sample measurements may be Fourier transformed.

The frequency-dependent ratio of the two spectra, defined as the transfer function, is given as

$$T ( ω ) = \frac{{E}_{sample} ( ω )}{{E}_{ref} ( ω )} = \frac{{r}_{prism - sample}^{p}}{{r}_{prism - air}^{p}} , \qquad Formula ( 1 )$$

where E_{ref} (ω) and Eₛₐₘₚₗₑ (ω) are the Fourier transform of the electric field for the reference and sample measurements, and rₚᵣᵢₛₘ₋ₐᵢᵣ and rₚᵣᵢₛₘ₋ₛₐₘₚₗₑ are the Fresnel reflection coefficients for the reference and sample measurements, respectively.

The complex refractive index of the sample, retrieved from this transfer function, is given by

$${\tilde{n}}_{sample} = \frac{1}{ϕ} \sqrt{\frac{1}{2} ( 1 \pm \sqrt{1 - ( 2 ϕ {n}_{prism} sin {( {θ}_{atr} )}^{2} )} )} , \qquad Formula ( 2 )$$

where Φ is

$$ϕ = \frac{cos ( {θ}_{atr} )}{{n}_{prism}} ( \frac{1 - T \cdot {r}_{prism - air}^{p}}{1 + T \cdot {r}_{prism - air}^{p}} ) . \qquad Formula ( 3 )$$

Attenuated Total Reflection (ATR) mode allows the plastic on the conveyor belt to be tested without having the need to be pressed down. In the experiments carried out, samples were tested on the THz ATR prism stage without pressing them down onto the stage. This compares favorably to conventional THz ATR tests, whereby the samples are normally pressed hard onto the prism surface to achieve sensitive and repeatable results, which is, however, not practical in real plastic sorting detection flow line, as doing so may significantly reduce detection and sorting speed, which translates into increase in overall costs.

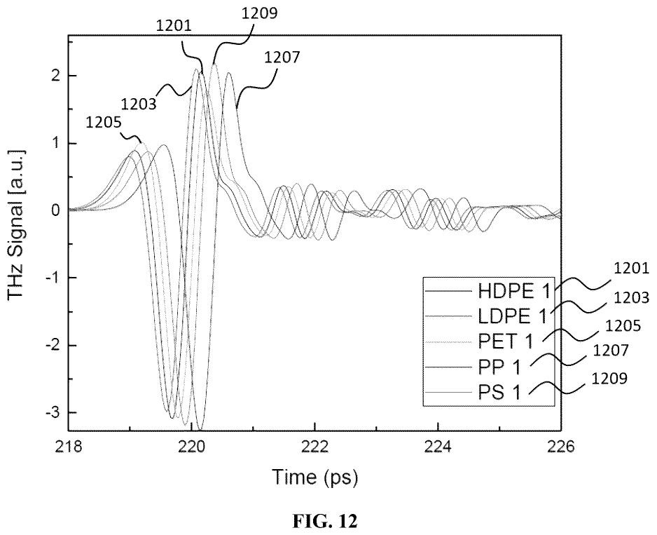

Due to different sample sizes and shapes, different spacings between the prism stage and sample surface may exist, and this may be reflected by different time delays in the THz TDS time domain spectra, as shown in FIG. 12. The time delay may relate or correlate with different spacings between the prism stage and sample surface.

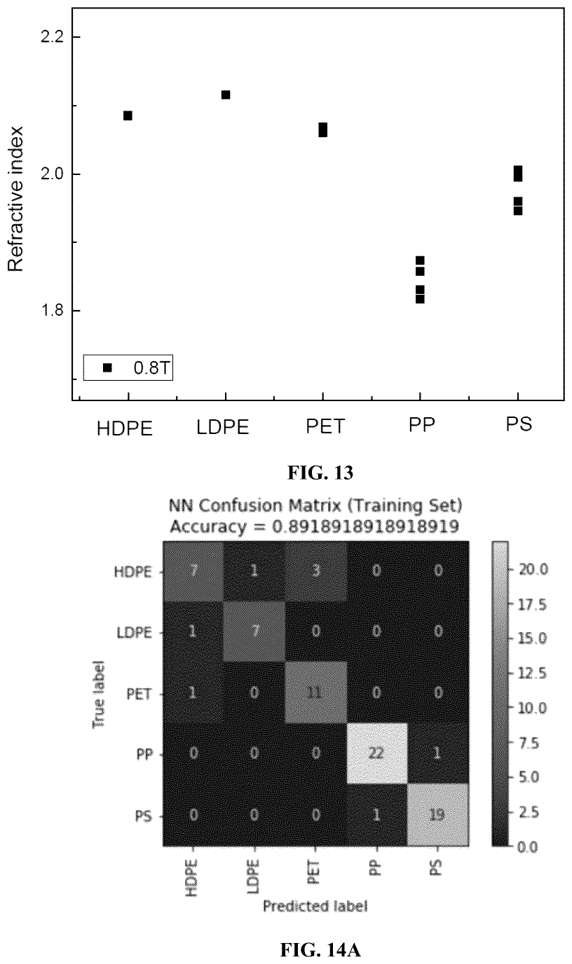

Pre-processing of the time domain data to identify the prism-air interface and air-plastic interface were performed, after which gap spacing effect were removed from the time domain spectra. Subsequently, the refractive index, dielectric constant and absorption coefficient were recalculated using Formulas (1), (2) and (3) stated above. Material parameters such as absorption spectra, refractive index and dielectric constant were used to implement machine learning. FIG. 13 shows the results of the calculated refractive index for different plastic types.

Finally, processed data with higher degree of discrimination were input for machine learning to further enhance the classification accuracy. The dataset comprises THz spectra for 5 types of plastics with each type having more than 10 samples. The dataset was separated into training set and test set based on a 50:50 ratio.

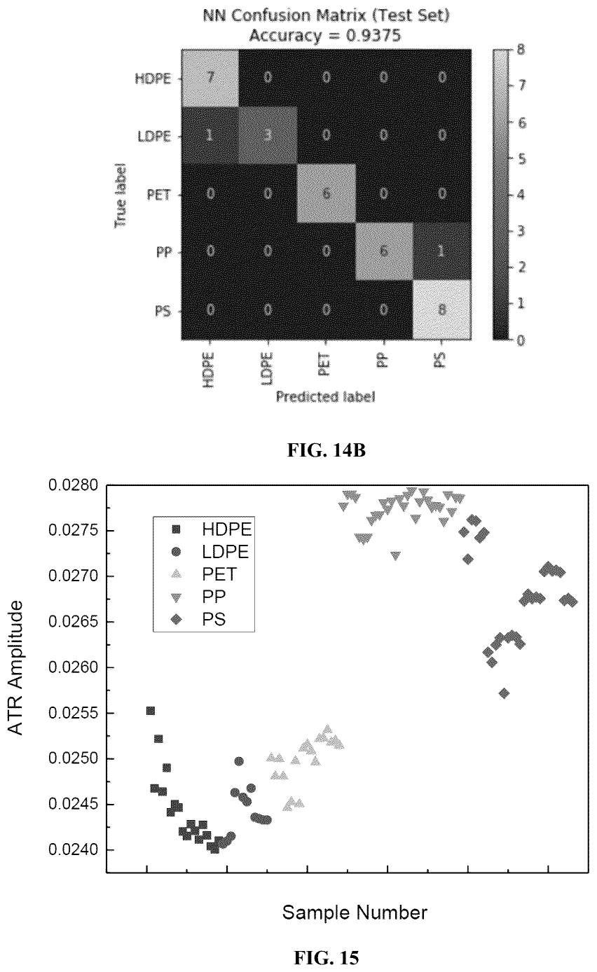

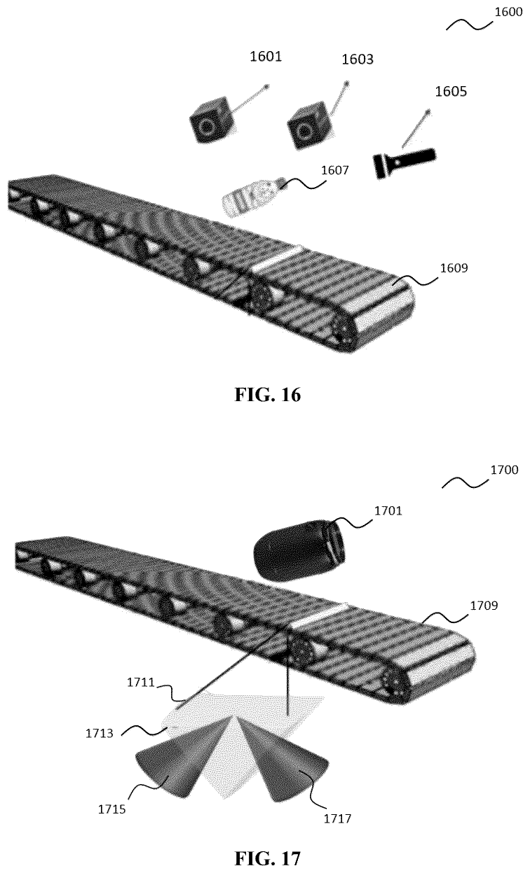

The machine learning algorithms—Neural Network Classifier (NN)—were first trained on the training set, and then evaluated by predicting the test set. The test set prediction accuracy was then computed as a gauge to determine the performance of the trained algorithms for predicting on unseen data. FIG. 14A and FIG. 14B show the results on the training set and test set, respectively. It is expected that results may be further improved with more training data.

Novel features and inventiveness of technology disclosed herein may include:
1. Use of active thermography to complement use of hyperspectral imaging (covering near-infrared range) for detection of dark plastic materials. The dark plastic materials may be difficult to detect using hyperspectral imaging due to low reflectance, but may be easily picked up by active thermography due to increased emissivity of dark colored objects which appear significantly on thermal images, as compared to objects which are lighter colored.
2. Adoption of ATR testing scheme. Plastic samples running in the flow line may be tested without having to press down the samples, or to involve other human interference. This has potential to lower detection cost and improve efficiency.
3. Pre-processing of time domain data to identify prism-air interface and air-plastic interface. Time delay of the two peaks may show the air gap size, which could be changed by sample shapes, as well as sample size and weight.
4. The second peak that was picked up corresponding to air-plastic interface can be further processed, e.g. de-noise and normalized. The second peak may contain information from the plastic material. Other influences can be removed or minimized.
5. Calculation of the absorption spectra, refractive index and dielectric constant of the plastic materials.
6. The material parameters such as absorption spectra, refractive index and dielectric constant can be used to implement machine learning.
7. This is the first time influences from interfaces or air gap have been removed in material machine learning techniques, as well as use of THz ATR for plastic sorting. This is a key insight based on inventors' unique domain expertise, from which enhanced accuracy from the different plastic identifications have been achieved and demonstrated.
8. A machine learning workflow for sorting the plastic according to their polymer structures based on the THz signal with the following exemplary features:

| | | ATR + Far IR (THz) |
|---|---|---|
| | HSI + IRT Technique | Technique |
| Optical source OR | A wavelength of 350- | A THz broadband emission |
| Illuminator System | 3500 nm acting as a | of 0.1 THz to 4 THz. |
| | hyperspectral optical source | |
| | as well as a thermal | |
| | excitation source (e.g. 2 × | |
| | 400 W Halogen lamps). | |
| Detector System OR | Hyperspectral imaging | A terahertz detector system |
| Imaging System | system (wavelength, ideally: | for receiving THz broadband |
| | 900-1700 nm or higher) | signal. |
| | A thermal imaging system | |
| | (e.g. 640 × 480 pixels, <30 mK | |
| | NETD; FLIR A655SC). | |
| Data Acquisition System OR | A signal processing system to | A detection system to receive |
| Signal Processing System | receive and process, | THz range broadband signal, |
| FOR Machine Learning (ML) | hyperspectral data cubes | wherein said signal |
| | from the hyperspectral | processing system processes |
| | imaging system (e.g. | said detection signal to |
| | SpecGrabber and | provide a measurement of |
| | CubeCreator Software) or | plastic parameters. |
| | thermal signals from thermal | |
| | camera (e.g. ResearchIR or | |
| | FLIR Thermal Studio). | |

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A system operable to identify and sort materials of different plastics, the system comprising:
an illumination module operable to emit light at materials of different plastics, wherein the illumination module comprises a hyperspectral optical source and a thermal excitation source, wherein the hyperspectral optical source is operable to emit light ranging from ultraviolet light to infrared light;
an imaging module comprising a hyperspectral detector and a thermal imaging camera each configured to detect light from the illumination module reflected by the materials of different plastics, wherein the hyperspectral detector is operable to convert detected light into hyperspectral signal and the thermal imaging camera is operable to convert detected light into thermal image; and
a data acquisition module comprising a hyperspectral signal processing unit and a thermal signal processing unit, wherein the hyperspectral signal processing unit is operable to generate hyperspectral data from the hyperspectral signal and the thermal signal processing unit is operable to generate thermal imaging data from the thermal image, wherein the materials of different plastics are identifiable from the hyperspectral data and the thermal imaging data.

2. The system of claim 1, wherein the hyperspectral optical source is operable to emit light having a wavelength of 350 nm to 5000 nm.

3. The system of claim 1, wherein the thermal excitation source comprises one or more light sources, wherein the one or more light sources comprise halogen lamps or are operable to project light comparable to natural sunlight.

4. The system of claim 1, wherein the hyperspectral detector is operable to detect light having a wavelength of at least 400 nm reflected by the materials of different plastics.

5. The system of claim 1, wherein the hyperspectral optical source, the thermal excitation source, the hyperspectral detector and the thermal imaging camera, remain stationary during operation.

6. The system of claim 1, further comprising a machine learning module trainable to identify the materials of different plastics and have the conveyer module categorize the materials of different plastics for sorting.

7. A system operable to identify and sort materials of different plastics, the system comprising:
an illumination module operable to emit light at materials of different plastics, wherein the illumination module comprises a terahertz infrared broadband emission source operable to emit light;
an imaging module comprising a terahertz infrared detector coupled to a prism, wherein the prism is positioned to contact each of the materials in the absence of any force exerted on the prism and the materials to render the contact, wherein the terahertz infrared detector is configured to detect light from the illumination module reflected by the materials of different plastics, wherein the terahertz infrared detector is operable to convert detected light into terahertz signal, wherein the prism renders attenuated total reflection; and
a data acquisition module comprising a terahertz signal processing unit operable to generate a time domain data from the terahertz signal, wherein the materials of different plastics are identifiable from one or more properties of the materials of different plastics calculated using the time domain data.

8. The system of claim 7, wherein the terahertz infrared broadband emission source is operable to emit light having a frequency of 0.1 THz to 10 THz.

9. The system of claim 7, wherein the prism comprises silicon, sapphire, Teflon, and/or polypropylene.

10. The system of claim 7, wherein the prism has a resistivity of 7 kΩ-cm or more.

11. The system of claim 7, wherein the prism is positioned in a path which the light emitted from the terahertz infrared broadband emission source travels to the materials of different plastics.

12. The system of claim 7, wherein the data acquisition module is operable to identify a terahertz signal which corresponds to a prism-air interface from the time domain data and discounting the terahertz signal corresponding to the prism-air interface from one or more other terahertz signals to identify one or more terahertz signals respectively corresponding to the materials of different plastics.

13. The system of claim 7, further comprising:
a conveyer module which conveys the materials of different plastics from one point to another; and
an electronic module operable to continuously adjust the terahertz infrared broadband emission source and the terahertz infrared detector, to a position along the conveyer module for
(i) the terahertz infrared broadband emission source to emit light at one or more of the materials and
(ii) the terahertz infrared detector to detect the light reflected by the materials of different plastics.

14. The system of claim 7, further comprising a machine learning module trainable to identify the materials of different plastics and have the conveyer module categorize the materials of different plastics for sorting.

15. The system of claim 7, wherein the one or more properties comprise refractive index of a plastic, absorption coefficient of a plastic, and/or dielectric constant of a plastic.

16. A plastic sorting system comprising the system of claim 1 and the system of claim 7.

17. A method of identifying and sorting materials of different plastics, the method comprising:
operating the illumination module in a system of claim 1 or claim 7 to emit light at materials of different plastics;
configuring the imaging module in a system of claim 1 or claim 7 to detect light from the illumination module reflected by the materials of different plastics; and
having the data acquisition module in a system of claim 1 generate hyperspectral data and thermal imaging data for identifying the materials of different plastics or having the data acquisition module in a system of claim 7 generate a time domain data for identifying the materials of different plastics.
